(19) United States
(12) Patent Application Publication
(10) Pub. No.: US 2010/0205106 A1
(43) Pub. Date: Aug. 12, 2010

(54) METHOD AND DEVICE FOR INCREASING THE OPERATIONAL SAFETY OF A SYSTEM

(76) Inventor: Ariane Sutor, Grafelfing (DE)

Correspondence Address: King & Spalding LLP, 401 Congress Avenue, Suite 3200, Austin, TX, 78701, US

(21) Appl. No.: 12/676,407

(22) PCT Filed: Jun. 25, 2008
(86) PCT No.: PCT/EP08/58046

§ 371 Date: Mar. 4, 2010

(30) Foreign Application Priority Data
Sep. 7, 2007 (DE) 10 2007 042 587.4

(51) Int. Cl. G06Q 10/00; G06N 5/02

(52) U.S. Cl. 705/348; 706/52

(57) ABSTRACT

A method for increasing the operational safety of a system with regard to an event impairing said operational safety, has the following steps: preparing structured assessment information concerning the event, whereby a frequency value is stored in a data structure as an item of assessment information for each damage parameter value from each quantity (S) of preset damage parameter values and for a probability from a quantity (P) of predetermined probabilities, evaluating the assessment information data of the data structure in order to calculate a risk of the event impairing the operational safety.

### CROSS-REFERENCE TO RELATED APPLICATIONS

This application is a U.S. National Stage Application of International Application No. PCT/EP2008/058046 filed Jun. 25, 2008, which designates the United States of America, and claims priority to German Application No. 10 2007 042 587.4 filed Sep. 7, 2007, the contents of which are hereby incorporated by reference in their entirety.

### TECHNICAL FIELD

The invention relates to a method and a device for increasing the operational safety of a system, with regard to an event impairing the operational safety of the system.

### BACKGROUND

The objective of technical risk management is to promptly identify problems during operation thereby increasing operational safety. These risks, which may materialize within the scope of an operation of a system, for instance an installation or a project for example, are analyzed so that, on the one hand, reserves can be set up to cover the expected costs caused by the risks, and on the other hand as technically efficient measures as possible can be taken to reduce the risks.

A plurality of different events exist, which, in different fields such as, for example, plant construction, or power station or medical engineering, can damage or reduce operational safety. If the construction of gas turbines is considered, an event impairing the operational safety for example is the situation where the dimensions of the components of a gas turbine do not match each other. This may cause vibrations in the gas turbine during operation, which may be hazardous for the given installation, and for its surroundings. A further example from the field of transport technology is the failure of a sensor in the door of a train carriage.

A risk can be defined as a calculated prediction of a possible damage. A risk can be considered as being the probability of the occurrence of a negative event, that is, an event impairing operational safety, multiplied by the damage parameter value of a damage caused by the event.

Separate risks, in respect of possible damage during operation of a system, are normally found out within the scope of risk workshops and are assessed with regard to the scale and likelihood of the damage. The product of probability plus damage produces the (separate) risk. The overall risk is then determined by adding up the (separate) risks.

Such a procedure is however insufficiently accurate, since the sum of the (separate) risks is, for the most part, too weak as a statement. Those responsible and/or engineers of the given operation or technical installation can often disagree on how high a risk there is in connection with a potential or insufficiently well known event that reduces operational safety. On account of the different conceptions involved in the method existing until now, it is generally not possible to take a certain range of risk into account when determining a given risk. In order to increase operational safety in a way that is carefully planned and efficient, it is however necessary to also take an area or variation range, around the determined total risk, into account.

### SUMMARY

According to various embodiments, improved risk assessment can be ensured, and thereby operational safety with regard to an event impairing the operational safety of a system can be increased.

According to an embodiment, a method for increasing the operational safety of a system with regard to an event impairing said operational safety, may have the following steps:
preparing structured assessment information concerning the event, whereby a frequency value is stored in a data structure as an item of assessment information for each damage parameter value from each quantity of preset damage parameter values and for a probability from a quantity of predetermined probabilities;
evaluating the assessment information data of the data structure in order to calculate a risk of the event impairing the operational safety:
calculation of a damage parameter value to be expected for each item of assessment information of the data structure;
calculation of the probability of occurrence for the damage parameter value to be expected for each item of assessment information of the data structure; and
calculation of a product for each item of assessment information from the data structure, whereby the product is determined on the basis of the calculated, expected damage parameter value and the calculated probability of occurrence.

According to a further embodiment, the determination of a risk may show the adding of the calculated products for each item of assessment information from the data structure. According to a further embodiment, the frequency value may show the relative frequency with which the damage parameter value with a given probability is specified. According to a further embodiment, a probability that damage will lie below a preset threshold value after the event impairing operational safety occurs can be calculated. According to a further embodiment, the preset threshold value can be determined by means of at least one threshold value. According to a further embodiment, calculation of the probability may show the summation of the probabilities of assessment information, from the data structure, occurring, whereby a probability of occurrence of an item of assessment information is only added, if a comparison of an absolute value of a difference between the expected damage parameter value and the determined risk with the fixed threshold value gives a positive result.

According to another embodiment, a device for increasing operational safety with regard to event impairing said operational safety, may have:
a memory to store a data structure of assessment information data concerning the event, whereby a frequency value is stored in the data structure as an item of assessment information for each damage parameter value from a set quantity of the damage parameter values, and for each probability from a set quantity of probabilities; and with
an evaluation unit for evaluating the assessment information data of the data structure to calculate a risk of the event impairing the operational safety,
   with the evaluation of the assessment information data having:
calculation of a damage parameter value to be expected for each item of assessment information of the data structure;
calculation of the probability of occurrence for the damage parameter value to be expected for each item of assessment information of the data structure; and
calculation of a product for each item of assessment information from the data structure, whereby the product is determined on the basis of the calculated, expected damage parameter value and the calculated probability of occurrence.

According to yet another embodiment, a computer program with program commands may carry out the method as described above.

According to a further embodiment, the computer program can be stored on a data carrier.

According to yet another embodiment, a data carrier may comprise a computer program as described above.

### BRIEF DESCRIPTION OF THE DRAWINGS

The method and device according to the invention are described below, in detail, with reference to the appended figures, in which;

FIG. 1 shows a table which forms a data structure of assessment information in accordance with a simple exemplary application;

FIGS. 2A-2D show a result of the evaluation of assessment information from the data structure, in accordance with an exemplary embodiment;

FIGS. 3A-3D show a further result of the evaluation of assessment information from the data structure if assessment information, in accordance with an exemplary embodiment; and

FIG. 4 shows a device for facilitating operational safety, with regard to an event impairing the operational safety, in accordance with an exemplary embodiment.

### DETAILED DESCRIPTION

According to various embodiments, a method for increasing the operational safety with regard to an event impairing the operational safety of a system, may comprise:
the preparation of structured assessment information data concerning the event, whereby a frequency value is stored in a data structure as an item of assessment information relative to a damage parameter value from a predetermined quantity of damage parameter values and relative to a probability from a predetermined quantity of probabilities;
evaluation of the assessment information data of the stored data structure in order to calculate a risk of the event impairing the operational safety.

The system may be a technical installation, a complex component having several modules or a project. The damage parameter is any relevant parameter of a case of damages, the temporal duration of a case of damages or the extent of such a case of damage for example.

By evaluating several assessment information data, it is possible to consider different views or assessments of the event impairing and/or reducing operational safety, and thereby the risks arising during a risk assessment. This therefore ensures a versatile, comprehensive risk analysis.

The assessment information is presented here in a structured form. A frequency value is specified for each damage parameter value from a quantity of damager parameter values and for each probability of an occurrence of the event reducing the operational safety from a quantity of probabilities. The method according to various embodiments thereby enables a fast, structured risk assessment.

The data structure used for the assessment information can be any data structure used to represent data. Two-dimensional arrays, tables or matrices or other suitable data structures can be used for example. This therefore enables a flexible implementation of the present method according to various embodiments.

The analysis of each item of assessment information of the data structure of assessment information can occur by means of the following steps:
calculation of a damage parameter value to be expected for each item of assessment information from the data structure;
calculation of the probability of occurrence for the damage parameter value to be expected for each item of assessment information of the data structure; and
calculation of a product for each item of assessment information from the data structure, whereby the product is determined on the basis of the calculated, expected damage parameter value and the calculated probability of occurrence.

In this way, risk appraisals are obtained for each of the assessments information. This represents a distinctly improved input for the risk analysis, since different evaluations of the damaging event can be considered in a structured way.

A risk can furthermore be determined by adding the calculated products for each of the assessment information of the data structure. The product forms the result of specific logical or arithmetic connections. In the present case, the product can be the result of a connection between an expected damage parameter value and the calculated probability of occurrence. With this, the connection can be any arithmetic operation such as multiplication, addition, subtraction or suchlike.

In accordance with one embodiment the frequency value can show a relative frequency with which the damage parameter value with the probability is specified in the data structure.

Furthermore, the method according to various embodiments can determine a probability that damage will lie within the scope of a predetermined range of damage parameter values, following occurrence of the event that impairs operational safety. With this, a predetermined damage parameter threshold value can be determined by means of at least one threshold value.

In one embodiment, determination of the probability includes the summation of the probabilities of occurrence of assessment information of the data structure, whereby a probability of the occurrence of an item of assessment information is only added if a comparison of an absolute value of a difference between the expected damage parameter value and the determined risk with the fixed threshold value gives a positive result.

In this way, further statements can be made about an event. This enables an efficient, effective assessment of the probability of damages lying within a certain range.

The above object is also achieved by means of a device with the features specified in claim 8.

The aforementioned object is also achieved by means of a computer program which comprises program coding, which is configured so that the steps of the method can be carried out in accordance with one of claims 1 to 7. In accordance with an exemplary embodiment, the computer program is stored here on a data carrier.

The following two quantities S and P are considered in accordance with an exemplary embodiment.

S:={s₁, . . . , sₖ} here represents a predetermined quantity of possible damage parameter values, within the context of a risk to be assessed. The damage parameter values in question can, for example, be queried or put before persons, for choice, as part of an interview, or be read out from a database. Different damage parameters such as, for example, the time that damage lasts or an evaluated level of damage (S), can be considered.

P:={p₁, . . . , pₙ} represents a predetermined quantity of possible probabilities with which the damages may arise. Also these probabilities in question can be queried, or put before persons as a choice as part of an interview, or be read out from a database.

In one embodiment of the method, the following probability range is considered on the basis of the two quantities S and P,:

{S×P, P(S×P), P),

whereby the probability P to the power set P_{(S×P)} of S×P is given by the covariance

{p_{1,1}, . . . , p_{1,n}, p_{2,1}, . . . , p_{k,n}}

whereby

P({(sᵢ,pⱼ)})=p_{i,j}

whereby S×P represents the damages to be expected and p_{i,j} represents the occurrence probabilities for the expected damage parameter values. A damage parameter value is, for example, an assessed level of damage or the expected duration of damage in hours.

The probability of occurrence p_{i,j} can, for example, be obtained within the context of a survey as the relative frequencies with which the damage Sᵢ is mentioned with the probability pⱼ, and can then be provided, to be read out, in a database.

Participants can, for example, within the scope of a workshop 20, be asked about the likelihood of the breakdown of a turbine, which represents an event that reduces operational safety, and about the losses arising thereby. The query is here carried out with regard to predetermined quantities S (the quantity of all possible losses) and P (the quantity of all possible probabilities):

S:={1 000 000$, 1 500 000$, 2 000 000$} and

P:={1%, 5%, 10%, 20%}.

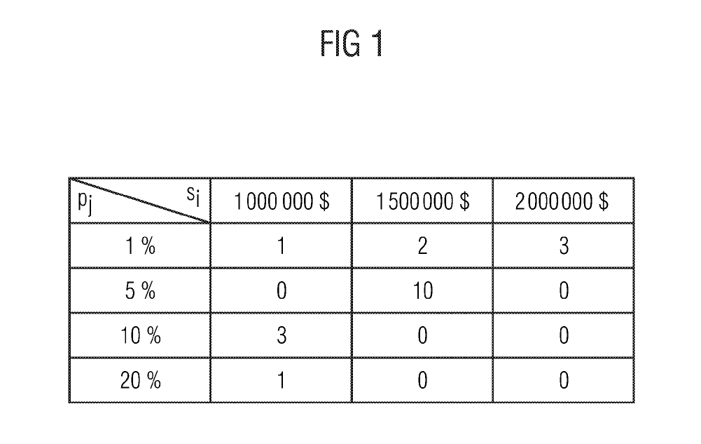

The results of the query, that is, the assessment information, are then recorded and stored in the table in accordance with FIG. 1.

In accordance with the present exemplary appliance, a table is used as a structure of assessment information or as a data structure for representing assessment information. As mentioned above, other (data) structures can also be used, such as arrays, lists, hash structures, or suchlike.

Each assessment information corresponds to an entry into the stored table, and comprises the damage parameter value, which is specified in the table as a column heading, the probability, which is specified as a row heading, and the frequency value, that is, the stored entry of the relevant damages column and probability row. The frequency value shows how many of the 20 workshop participants have regarded the given probability and damage parameter value as the correct combination for the breakdown of a gas turbine.

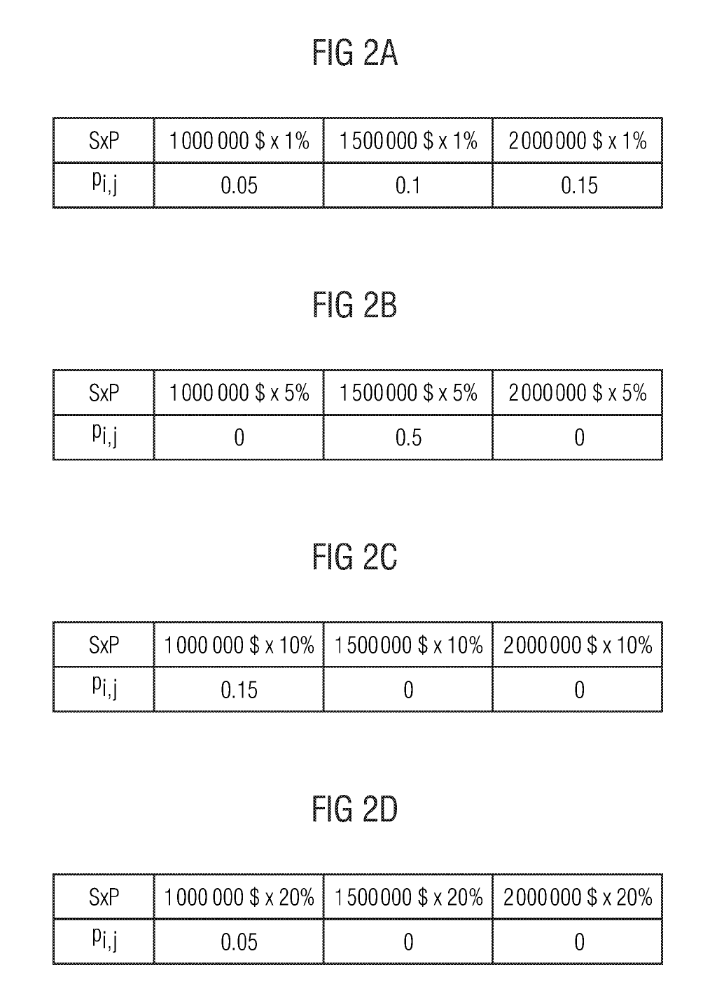

The tables in FIGS. 2a, 2b, 2c and 2d show the results obtained, in the stated example, as a result of a first evaluation step of the assessment information. The respective occurrence probabilities p_{i,j} are calculated for the given level of damages sᵢ for each assessment information, whereby p_{i,j}, in the present exemplary embodiment, indicates what percentage of the 20 participants have regarded the given probability and level of damage as the right combination for a turbine breakdown.

In order now to calculate the separate risk or the level of damage to be expected for each item of assessment information, an actual value of a random variable R is calculated:

R:S×P→R, (sᵢ, pⱼ)→sᵢ·pⱼ

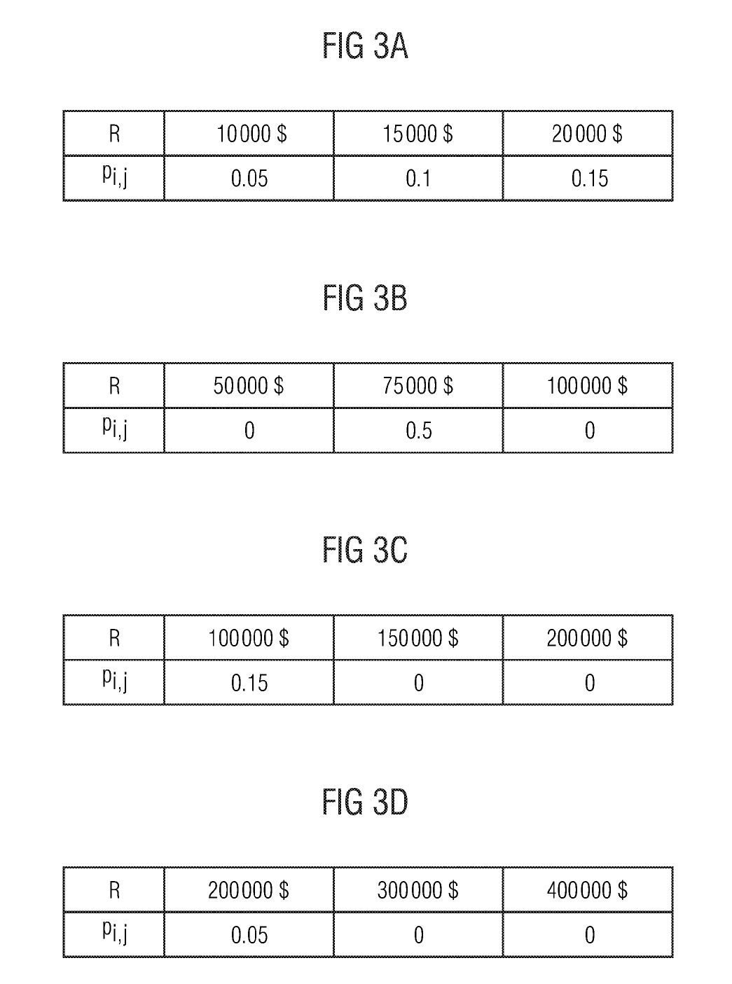

The result of the calculation of the level of expected damages is shown, in the tables of FIGS. 3a, 3b, 3c and 3d as a further evaluation step. Each R here corresponds to a multiplication of a sum of damages sᵢ and a probability pⱼ.

The risk is then given as an expected value of R:

$$risk := 𝔼 ( R ) = {\sum }_{{i = 1 , … , k}_{j = 1 , … , n}} {s}_{i} \cdot {p}_{j} \cdot {p}_{i , j} = {\sum }_{{i = 1 , … , k}_{j = 1 , … , n}} R \cdot {p}_{i , j}$$

A product is thereby determined for each item of assessment information, comprising the expected level of damage R and the probability of occurrence p_{i,j}. In accordance with the present exemplary embodiment, the expected level of damage R and the probability of occurrence p_{i,j} is multiplied in order to obtain the product for the assessment information. The risk of the event that reduces operational safety corresponds to the sum of the products of the assessment information:

risk= [symbol] (R)=67 500$.

Furthermore, in one embodiment of the method, the variance of the random variable R is calculated, whereby the variance shows the breadth of distribution of the random variable. The variance σ²′ as a measure of the variation of the risk, is therefore:

$${σ}^{2} ( R ) := {\sum }_{{i = 1 , … , k}_{j = 1 , … , n}} {( {s}_{i} \cdot {p}_{j} - risk )}^{2} \cdot {p}_{i , j}$$

Furthermore, alongside the risk, one obtains an estimate for fluctuations, whereby the Chebyschev-Markov inequalities can be used:

$$P ( \{ ( {s}_{i} , {p}_{j} ) ∈ S \times P ; \vert R ( {s}_{i} , {p}_{j} ) - risk \vert < α \} ) \geq 1 - \frac{1}{{α}^{2}} {σ}^{2} ( R ) .$$

Moreover, in one embodiment of the method, a probability that a loss will lie within the scope of a predetermined level of damage, following the event that reduces operational safety, e.g. the failure of a turbine, is determined.

From the above simple exemplary application, it emerges that:

P({(sᵢ, pⱼ)εS×P; |R(sᵢ,pⱼ)−risk|≦75 000})=0.5

P({(sᵢ, pⱼ)εS×P; |R(sᵢ,pⱼ)−risk|≦32 500})=0.65

P({(sᵢ, pⱼ)εS×P; |R(sᵢ,pⱼ)−risk|≦47 500})=0.8

Here, probabilities of the occurrence of assessment information from the data structure are added up to determine the probability, whereby an probability of occurrence of an item of assessment information from the data structure is only then added if a comparison of an absolute value of a difference between the expected level of damage and the determined risk with the at least one threshold value gives a positive result.

This obtains, for example, a 50% probability of a damage between $60,000 and 75,000, a 65% probability of a damage between $35,000 and 100,000, and an 80% probability of a damage between $20,000 and 110,000.

With a plurality of stochastically independent, separate damages, the expected value and the variance can be calculated additively in accordance with the above procedure. In order to minimize computing costs, the Chebyschev-Markov inequalities are preferably used to calculate the confidence intervals.

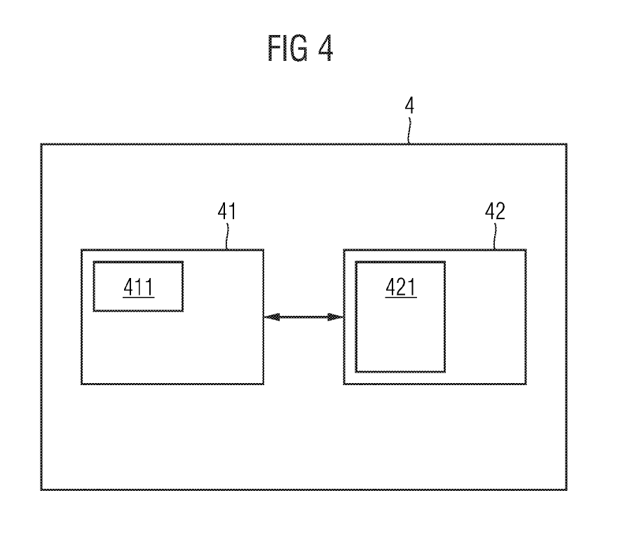

FIG. 4 shows a simple block diagram of a device 4 for increasing operational safety, with regard to an event impairing said operational safety, in accordance with an exemplary embodiment.

The device 4 has a storing unit or a memory 41 and an assessment or calculation unit 42, formed by a processor for example.

A data structure 411 of assessment information is stored in the memory 41. Memory space is used efficiently, because the assessment information 41 are recorded in a structured form. Structured evaluation or analysis of the assessment information is also possible, such that processing the calculation of results can occur quickly.

By means of the processor 42, the device 4 is advantageously designed or configured such that the assessment information from the data structure 411 of assessment information can be evaluated as described above and a risk of the event that reduces operational safety is determined as described above, after assessment of each assessment information from the data structure 411 of assessment information.

The described procedure ensures fast and effective assessment of assessment information. This also has positive effects on the effectiveness and speed of data processing by the processor 42. In the process, the memory 41 and the processor 42 communicate with each other in order to exchange relevant data such as assessment information or evaluations of assessment information. With this, the memory 41 is preferably designed such that the results of the evaluations of the given assessment information and/or of the results of the method according to various embodiments are stored as a whole, to enable partial or full reuse at a later time, e for display purposes and/or for further analyses.

FIG. 4 shows a program 421, for increasing operational safety, which is carried out by the processor 42 and has a corresponding coding.

What is claimed is:

1-11. (canceled)

12. A method for increasing the operational safety of a system with regard to an event impairing said operational safety, having the following steps:
preparing structured assessment information concerning the event, wherein a frequency value is stored in a data structure as an item of assessment information for each damage parameter value from each quantity of preset damage parameter values and for a probability from a quantity of predetermined probabilities; and
evaluating the assessment information data of the data structure in order to calculate a risk of the event impairing the operational safety by:
calculating a damage parameter value to be expected for each item of assessment information of the data structure;
calculating the probability of occurrence for the damage parameter value to be expected for each item of assessment information of the data structure; and
calculating of a product for each item of assessment information from the data structure, whereby the product is determined on the basis of the calculated, expected damage parameter value and the calculated probability of occurrence.

13. The method according to claim 12, wherein the determination of a risk shows the adding of the calculated products for each item of assessment information from the data structure.

14. The method according to claim 12, wherein the frequency value shows the relative frequency with which the damage parameter value with a given probability is specified.

15. The method according to claim 12, wherein a probability that damage will lie below a preset threshold value after the event impairing operational safety occurs is calculated.

16. The method according to claim 15, wherein the preset threshold value is determined by means of at least one threshold value.

17. The method according to claim 16, wherein calculation of the probability shows the summation of the probabilities of assessment information, from the data structure, occurring, wherein a probability of occurrence of an item of assessment information is only added, if a comparison of an absolute value of a difference between the expected damage parameter value and the determined risk with the fixed threshold value gives a positive result.

18. A device for increasing operational safety with regard to event impairing said operational safety, comprising:
a memory to store a data structure of assessment information data concerning the event, wherein a frequency value is stored in the data structure as an item of assessment information for each damage parameter value from a set quantity of the damage parameter values, and for each probability from a set quantity of probabilities; and
an evaluation unit for evaluating the assessment information data of the data structure to calculate a risk of the event impairing the operational safety,
with wherein the evaluation unit is operable:
to calculate a damage parameter value to be expected for each item of assessment information of the data structure;
to calculate the probability of occurrence for the damage parameter value to be expected for each item of assessment information of the data structure; and
to calculate a product for each item of assessment information from the data structure, wherein the product is determined on the basis of the calculated, expected damage parameter value and the calculated probability of occurrence.

19. A computer program product comprising a computer readable medium storing program commands which when executed on a computer perform the steps of:
preparing structured assessment information concerning the event, wherein a frequency value is stored in a data structure as an item of assessment information for each damage parameter value from each quantity of preset damage parameter values and for a probability from a quantity of predetermined probabilities; and
evaluating the assessment information data of the data structure in order to calculate a risk of the event impairing the operational safety by:
calculating a damage parameter value to be expected for each item of assessment information of the data structure;
calculating the probability of occurrence for the damage parameter value to be expected for each item of assessment information of the data structure; and
calculating of a product for each item of assessment information from the data structure, whereby the product is determined on the basis of the calculated, expected damage parameter value and the calculated probability of occurrence.

20. The computer program product as claimed in claim 19, wherein the determination of a risk shows the adding of the calculated products for each item of assessment information from the data structure.

21. The computer program product as claimed in claim 19, wherein the frequency value shows the relative frequency with which the damage parameter value with a given probability is specified.

22. The computer program product as claimed in claim 19, wherein a probability that damage will lie below a preset threshold value after the event impairing operational safety occurs is calculated.

23. The computer program product as claimed in claim 22, wherein the preset threshold value is determined by means of at least one threshold value.

24. The computer program product as claimed in claim 23, wherein calculation of the probability shows the summation of the probabilities of assessment information, from the data structure, occurring, wherein a probability of occurrence of an item of assessment information is only added, if a comparison of an absolute value of a difference between the expected damage parameter value and the determined risk with the fixed threshold value gives a positive result.

25. The device according to claim 18, wherein the determination of a risk shows the adding of the calculated products for each item of assessment information from the data structure.

26. The device according to claim 18, wherein the frequency value shows the relative frequency with which the damage parameter value with a given probability is specified.

27. The device according to claim 18, wherein a probability that damage will lie below a preset threshold value after the event impairing operational safety occurs is calculated.

28. The device according to claim 27, wherein the preset threshold value is determined by means of at least one threshold value.

29. The device according to claim 28, wherein calculation of the probability shows the summation of the probabilities of assessment information, from the data structure, occurring, wherein a probability of occurrence of an item of assessment information is only added, if a comparison of an absolute value of a difference between the expected damage parameter value and the determined risk with the fixed threshold value gives a positive result.
